(19) United States
(12) Patent Application Publication
(10) Pub. No.: US 2006/0197746 A1
(43) Pub. Date: Sep. 7, 2006

(54) Method and apparatus for navigation guidance in user interface menu

(76) Inventor: Mikko Nirhamo, Kempele (FI)

Correspondence Address: Hollingsworth & Funk, LLC, Suite 125, 8009 34th Avenue South, Minneapolis, MN, 55425, US

(21) Appl. No.: 11/069,624

(22) Filed: Mar. 1, 2005

(51) Int. Cl. G06F 9/00

(52) U.S. Cl. 345/160; 715/856; 715/860; 715/810; 715/767

(57) ABSTRACT

A navigation guidance structure is provided for an unstructured user interface menu in an electronic device. According to the invention, selection components are provided in the unstructured user interface menu, and paths connect the selection components. A user may move a cursor through these paths using direction keys of an input device connected to the electronic device. The navigation guidance indicates that activation of a given direction key will move the cursor to indicate a particular selection component.

### FIELD

The invention relates to navigation guidance in an unstructured user interface menu of an electronic device.

### BACKGROUND

FIG. 1A illustrates a conventional structured user interface (UI) menu 100 of an electronic device. The user interface menu 100 may be displayed in a display unit of the electronic device. The user interface menu 100 comprises eight selectable components: ‘language options’, ‘play movie’, ‘setup’, ‘soundtrack’, ‘cast & crew’, ‘behind the scenes’, and ‘trailers’. These components may be accessed by moving a cursor 102 over the desired component and selecting the component. The cursor 102 may be moved using direction keys of an input device of the electronic device. In the case of structured user interface menu, such as the menu illustrated in FIG. 1A, it is obvious how to navigate in the menu. For example, it is clear to an average user that by selecting a direction key ‘down’ from the input device, the cursor 102 may be moved from the ‘play movie’ component to the ‘soundtrack’ component. Further, by selecting the direction key ‘down’ once more, and then direction key ‘left’, the cursor 102 may be moved over the ‘cast & crew’ component.

FIG. 1B illustrates an unstructured user interface menu 110 of an electronic device. An unstructured user interface menu may be used, for example, in order to improve the visual appearance of the menu. The user interface menu 110 comprises the same eight selectable components as the menu in FIG. 1A, but now the components are located differently. It is no longer obvious to an average user where a selection of a determined direction key moves a cursor 112. For example, when selecting the direction key ‘down’, will the cursor 112 move from ‘play movie’ to ‘language options’ or to ‘soundtrack’? The user must learn the logic of the user interface menu 110 through trial end error, which reduces the user friendliness of the unstructured user interface menu 110.

### BRIEF DESCRIPTION OF THE INVENTION

An object of the invention is to provide a navigation guidance solution for an unstructured user interface menu of an electronic device.

According to an aspect of the invention, there is provided a navigation guidance method of an unstructured user interface menu of an electronic device. The method comprises providing in a display unit of an electronic device an unstructured user interface menu with a plurality of selection components, providing one or more paths connecting a first selection component with at least a second selection component, providing a mechanism for moving a cursor from the first selection component to the at least second selection component connected to the first selection component, and displaying the one or more paths from the first selection component to at least the second selection component with an indication as to where the cursor would move upon activation of a given direction key of an input device connected to the electronic device.

According to another aspect of the invention, there is provided an electronic device comprising a display unit for displaying information, an input device, comprising a plurality of direction keys, for inputting information, and a control unit connected to the display unit and the input device. The control unit is configured to provide, in the display unit, an unstructured user interface menu with a plurality of selection components, provide one or more paths connecting a first selection component with at least a second selection component, provide a mechanism for moving a cursor from the first selection component to the at least second selection component connected to the first selection component, and display, in the display unit, the one or more paths from the first selection component to at least the second selection component with an indication as to where the cursor would move upon activation of a given direction key of the input device.

According to another aspect of the invention, there is provided a computer program product encoding a computer program of instructions for executing a computer process for navigation guidance related to an unstructured user interface menu of an electronic device. The process comprises providing in a display unit of an electronic device an unstructured user interface menu with a plurality of selection components, providing one or more paths connecting a first selection component with at least a second selection component, providing a mechanism for moving a cursor from the first selection component to the second selection component connected to the first selection component, and displaying the one or more paths from the first selection component to at least the second selection component with an indication as to where the cursor would move upon activation of a given direction key of an input device connected to the electronic device.

According to another aspect of the invention, there is provided a computer program distribution medium readable by a computer and encoding a computer program of instructions for executing a computer process for navigation guidance related to an unstructured user interface menu of an electronic device. The process comprises providing in a display unit of an electronic device an unstructured user interface menu with a plurality of selection components, providing one or more paths connecting a first selection component with at least a second selection component, providing a mechanism for moving a cursor from the first selection component to the second selection component connected to the first selection component, and displaying the one or more paths from the first selection component to at least the second selection component with an indication as to where the cursor would move upon activation of a given direction key of an input device connected to the electronic device.

An advantage the invention provides is that through navigation guidance in an unstructured user interface menu a user will know, where a cursor moves, when the user presses a determined direction key of an input device. This increases user friendliness significantly, since no need exists to try to find out the logic of the user interface menu.

### LIST OF DRAWINGS

In the following, the invention will be described in greater detail with reference to the embodiments and the accompanying drawings, in which

FIG. 1A illustrates a prior art structured user interface menu;

FIG. 1B illustrates a prior art unstructured user interface menu;

FIG. 2 illustrates an electronic device according to an embodiment of the invention;

FIG. 3A illustrates an unstructured menu with navigation guidance according to an embodiment of the invention;

FIG. 3B illustrates an unstructured menu with navigation guidance according to an embodiment of the invention;

FIG. 4 illustrates an unstructured menu with navigation guidance according to an embodiment of the invention;

FIG. 5A illustrates an unstructured menu according to an embodiment of the invention;

FIG. 5B illustrates an unstructured menu with a view zoomed in according to an embodiment of the invention, and

FIG. 6 is a flow diagram illustrating a process for navigation guidance related to an unstructured user interface menu according to an embodiment of the invention.

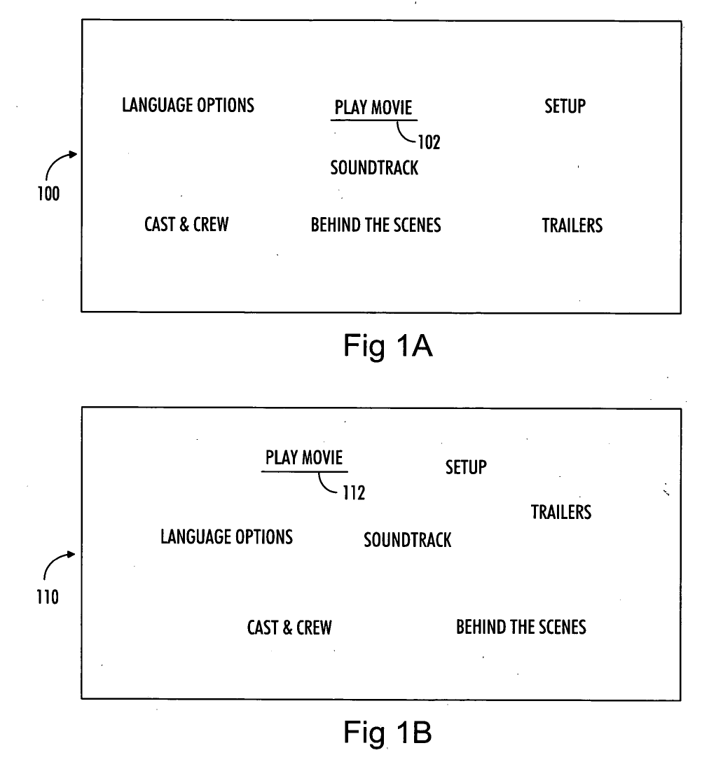

### DESCRIPTION OF EMBODIMENTS

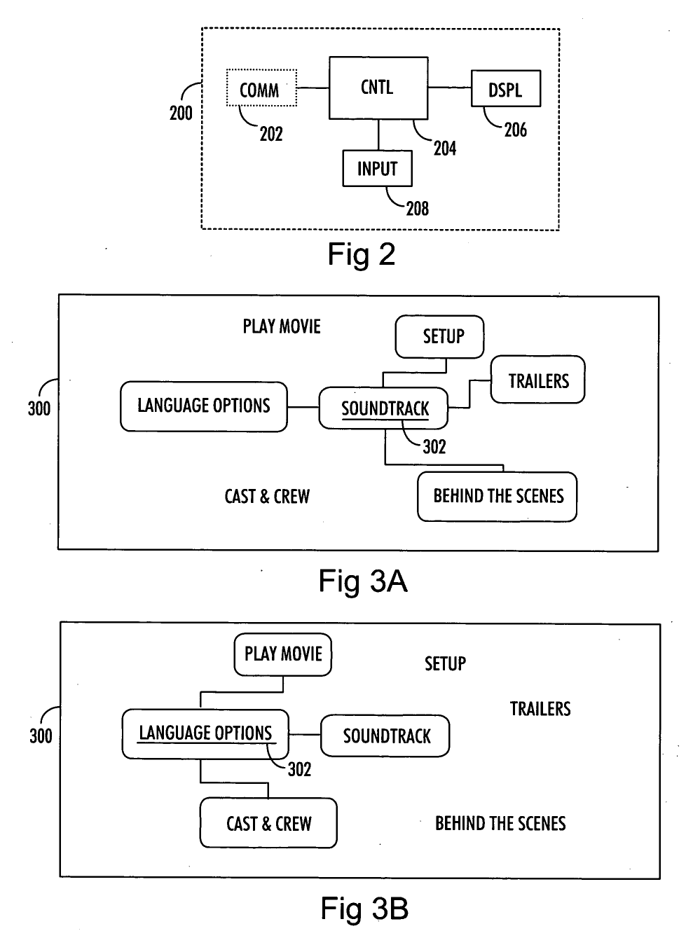

FIG. 2 illustrates an example of a structure of an electronic device 200 in which embodiments of the invention may be implemented. The electronic device 200 may, for example, be a computer, a laptop, a PDA (Personal Digital Assistant) or a mobile communication device. The electronic device may also be a media player, such as a CD (compact disc) player or a DVD (Digital Video Disc) player. The electronic device 200 may also be a combination of two electronic devices, such as a computer with a communication device connected to the computer, or a media player connected to a monitor. An example of a combination of a PDA and a mobile communication device is the Nokia Communicator®.

The electronic device 200 comprises a control unit 204 for controlling the operation of the electronic device 200. The control unit 204 may control the operation of the electronic device 200 according to inputs from a user. The control unit 204 may also control display of information to the user. The control unit 204 may be implemented with a digital signal processor with suitable software or with separate logic circuits, for example with ASIC (Application Specific Integrated Circuit).

The electronic device 200 further comprises a display unit 206 connected to the control unit 204 in order to display information to a user. The display unit 206 may be integrated into the electronic device 200 or it may be an external display unit, such as a monitor or a projector, connected to the electronic device 200.

The electronic device 200 further comprises an input device 208 for inputting information to the electronic device 200. The input device 208 may be a keypad integrated into the electronic device 200, or the input device 208 may be an external input device, such as a keyboard or a remote controller, having a communication link to the control unit 204. The input device 208 may comprise direction keys for inputting directional information into the electronic device 200. The direction keys may be implemented with a separate key for each direction or with a so-called rocker pad. The rocker pad may be a four-directional rocker pad or an eight-directional rocker pad. The display unit 206 and the input device 208 may also be combined by means of, for example, touch sensitive display. The display unit and the input device are parts of a user interface of the electronic device 200.

The electronic device may optionally further comprise a communication interface 202 connected to the control unit 204 for communication with other electronic devices or communication networks. The communication interface 202 may utilize either a wired or a wireless communication technology, and the communication technology does not limit the scope of the invention in any way.

Next, an embodiment of the invention will be described with reference to FIGS. 3A and 3B, which illustrate a navigation guidance structure implemented in an unstructured user interface menu 300. The unstructured user interface menu 300 may be a menu of a movie implemented on a digital media, such as a CD or DVD. The unstructured user interface menu 300 may also be a menu structure of a virtual environment, such as a forum-type of a www-site. The unstructured user interface menu 300 may also be a menu structure of a mobile communication device, a PDA or another corresponding electronic device. The unstructured user interface menu 300 may also be a menu structure in a user interface of a testing apparatus used for testing electronic devices. In general, the unstructured user interface menu 300 may be any kind of menu structure implemented in an electronic device. The unstructured user interface menu may also comprise a zooming option. For example, selecting a selection component may cause the interface to zoom in to display in more detail only the selected selection component and a limited area around the selection component. This so-called zooming user interface menu is particularly useful in user interfaces which comprise a large number of selection components and details.

The unstructured user interface menu 300 illustrated in FIGS. 3A and 3B comprises eight selection components: ‘language options’, ‘play movie’, ‘setup’, ‘soundtrack’, ‘cast & crew’, ‘behind the scenes’, and ‘trailers’. The selection components may comprise text, a figure or another visual object. The term ‘selection component’ refers to the fact that these components may be selected using an input device in order to perform determined operations. For example, the selection component ‘play movie’ may be selected in order to start playing the movie, the selection component ‘language options’ may be selected in order to adjust language settings and so on.

The unstructured user interface menu 300 may comprise a cursor 302 for indicating a selection component which may be selected currently by activating a selection key of the input device. The unstructured user interface menu 300 may further comprise one or more paths connecting the selection components with each other. Two selection components may be connected with each other directly, or through other selection components. The cursor 302 may be moved through these paths to indicate another selection component by using direction keys of the input device.

The unstructured user interface menu 300 according to an embodiment of the invention comprises navigation guidance for indicating where the cursor may be moved from the selection component the cursor currently indicates. Additionally, the navigation guidance may indicate that activation of a given direction key moves the cursor 302 to indicate a particular selection component.

The visible navigation guidance structure of FIG. 3A comprises a rounded rectangle around a first selection component (‘soundtrack’) which is indicated by the cursor 302, and the selection components (‘setup’, ‘trailers’, ‘language options’, and ‘behind the scenes’) directly connected to the first selection component, i.e. the selection components not connected to the first selection component through (an)other selection component(s). Thus, the cursor 302 may be moved to indicate any one of these selection components by using a single activation of a direction key of the input device. Additionally, the navigation guidance structure may display one or more paths connecting the first selection component and the selection components directly connected to the first selection component. The navigation guidance structure may display the one or more paths such that the user knows which direction key moves the cursor 302 to indicate a particular selection component. In the example of FIG. 3A, the path from the ‘soundtrack’ selection component to the ‘setup’ selection component starts from the topmost side of the rectangle surrounding the former selection component, i.e. the component the cursor 302 currently indicates. Thus, the user naturally realizes that, by activating the direction key ‘up’ of the input device, the cursor 302 moves to indicate the ‘setup’ selection component. Similarly, the path from the ‘soundtrack’ selection component to the ‘trailers’ component starts from the right side of the rectangle surrounding the ‘soundtrack’ selection component and, thus, by selecting the direction key ‘right’ of the input device, the cursor 302 moves to indicate the ‘trailers’ selection component. Paths to the ‘language options’ and ‘behind the scenes’ selection components start from the left side and the bottom side, respectively, so the cursor may be moved to indicate either of these by using the direction key ‘left’ or ‘down’, respectively.

When the cursor 302 has been moved over another selection component, the visible navigation guidance structure changes accordingly to display a rectangle around the selection component which the cursor 302 currently indicates and the selection components directly connected to the selection component which the cursor 302 currently indicates. Accordingly, the paths from the selection component the cursor 302 currently indicates are rear-ranged to indicate where activation of each direction key moves the cursor 302. As FIG. 3B illustrates, when compared to FIG. 3A, the cursor 302 has been moved to indicate the ‘language options’ selection component. The navigation guidance has been rearranged accordingly.

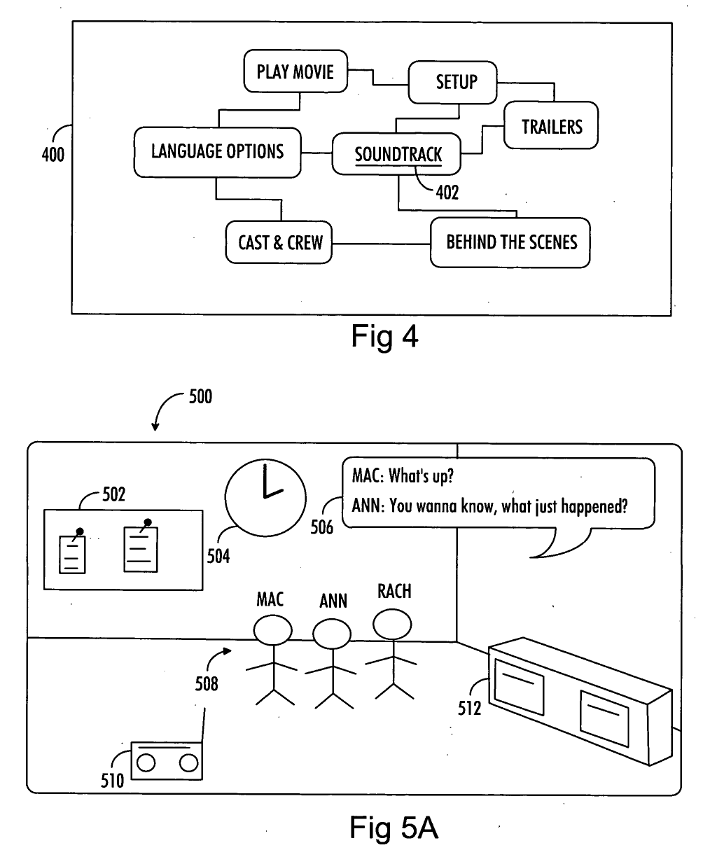

In the above example with reference to FIGS. 3A and 3B, the navigation guidance displays the paths from the selection component the cursor 302 currently indicates to the selection components directly connected to the selection component the cursor 302 currently indicates. According to another embodiment of the invention, the navigation guidance displays paths from the selection component the cursor currently indicates to all the other selection components. FIG. 4 illustrates an unstructured user interface menu 400 according to this embodiment of the invention with a complete navigation guidance displaying paths from any selection component to all the other selection components. The components directly connected to the selection component a cursor 402 currently indicates, as well as corresponding paths, may be highlighted to indicate better where the cursor 402 may be moved with a single activation of a direction key of the input device.

The navigation guidance may be hidden, if the user does not perform any action within a given period of time. Alternatively, the navigation guidance may be hidden if the user does not use any direction key of the input device during a determined period of time. In the latter case, the user may perform other actions not related to moving the cursor from one selection component to another by using the direction keys. The navigation guidance may be displayed again when the user performs a particular action, such as presses a direction key or another pre-determined key of the input device.

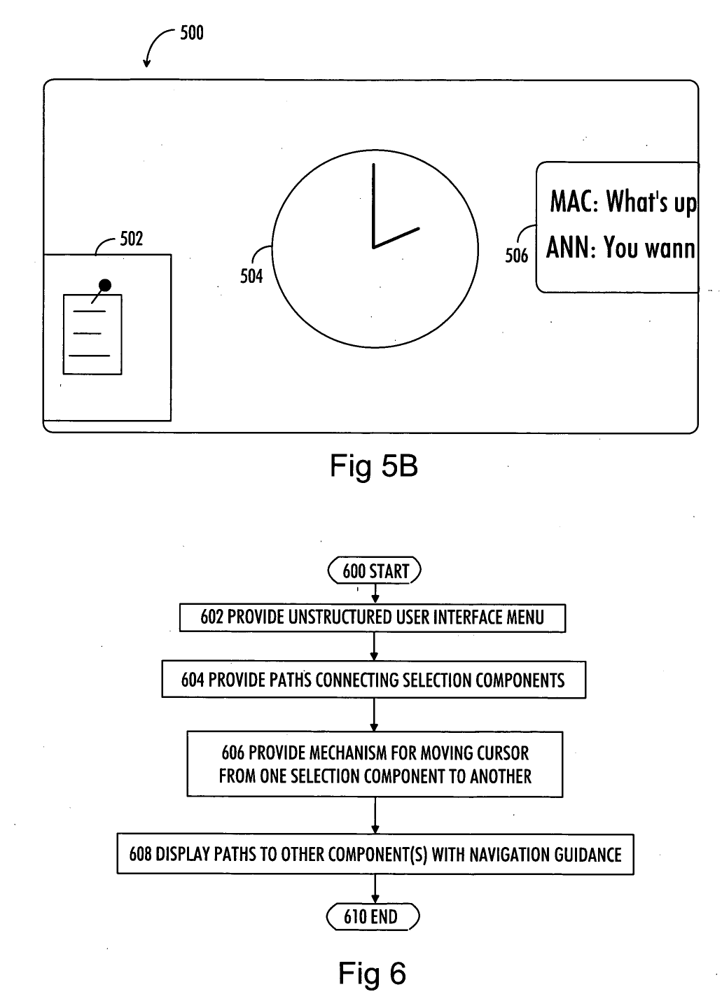

FIG. 5A illustrates a virtual environment type of an unstructured user interface menu 500. The user interface menu 500 comprises six selection components representing various possibilities for a user to be carried out in the virtual environment. The user may check a bulletin board 502 to check for announcements, check for time-related issues 504, such as schedules or official time around the world, participate in a conversation 508, check for conversation history 506, listen to the radio 510 or another corresponding media, or browse files or other items 512. Navigation guidance may be implemented in this user interface menu in the same way as in the above examples. The navigation guidance may be implemented such that it does not obscure details of the user interface unnecessarily. For example, the navigation guidance may be implemented such that it is transparent to some degree and is hidden if the user does not use any direction key of the input device during a given period of time.

The unstructured user interface menu 500 may also comprise a zooming option. If time-related issues 504 are selected by selecting the clock of the user interface menu, the view may be zoomed in to display the clock and a limited area around the clock as FIG. 5B illustrates.

Next, a process for navigation guidance in an unstructured user interface menu of an electronic device will be described with reference to the flow diagram of FIG. 6. The process starts in step 600. An unstructured user interface menu is provided in step 602. The user interface menu is provided in a display unit of the electronic device. The user interface menu comprises a plurality of selection components. A selection component may be selected by a user in order to perform a particular operation.

Paths connecting the selection components are provided in step 604. Typically, two selection components may be connected with a path directly and/or with multiple paths through other selection component or components.

In step 606, a mechanism is provided for moving a cursor from a first selection component to a second selection component. The mechanism may be triggered upon reception of a signal indicating activation of a direction key of an input device connected to the electronic device. The cursor may then be moved according to the received signal, i.e. according to which direction key was activated.

Paths from the first selection component to the second selection component or components are displayed along with navigation guidance in step 608. Only paths to selection components directly connected to the first selection component may be displayed, or all the paths between the selection components may be displayed. The navigation guidance indicates which direction key or keys should be activated in order to move the cursor from the first selection component to a second selection component. The process ends in step 610.

The electronic device of the type described above may be used for implementing the method, but also other types of electronic devices may be suitable for the implementation. In an embodiment, a computer program product encodes a computer program of instructions for executing a computer process of the above-described method of navigation guidance related to an unstructured user interface menu of an electronic device. The computer program product may be implemented on a computer program distribution medium. The computer program distribution medium includes all manners known in the art for distributing software, such as a computer readable medium, a program storage medium, a record medium, a computer readable memory, a computer readable software distribution package, a computer readable signal, a computer readable telecommunication signal, and a computer readable compressed software package.

Even though the invention has been described above with reference to an example according to the accompanying drawings, it is clear that the invention is not restricted thereto but it can be modified in several ways within the scope of the appended claims.

1. A navigation guidance method of an unstructured user interface menu of an electronic device, the method comprising:
providing in a display unit of an electronic device an unstructured user interface menu with a plurality of selection components;
providing one or more paths connecting a first selection component with at least a second selection component;
providing a mechanism for moving a cursor from the first selection component to the at least second selection component connected to the first selection component, and
displaying the one or more paths from the first selection component to at least the second selection component with an indication as to where the cursor would move upon activation of a given direction key of an input device connected to the electronic device.

2. The method of claim 1, further comprising displaying the path or paths from the first selection component to selection components directly connected to the first selection component.

3. The method of claim 1, further comprising displaying the path or paths from the first selection component to all other selection components.

4. The method of claim 3, further comprising highlighting the path or paths from the first selection component to the selection components directly connected to the first selection component.

5. The method of claim 1, wherein the mechanism is activated upon receiving an input indicating activation of a direction key of the input device connected to the electronic device.

6. The method of claim 1, further comprising displaying the path or paths from the first selection component to another selection component or other components after receiving an activation input from the input device.

7. The method of claim 1, further comprising hiding the display of the said path or paths from the first selection component to the at least second selection component when no input is received from the input device during a given time period.

8. An electronic device comprising:
a display unit for displaying information;
an input device, comprising a plurality of direction keys, for inputting information;
a control unit connected to the display unit and the input device, the control unit being configured to:
provide, in the display unit, an unstructured user interface menu with a plurality of selection components;
provide one or more paths connecting a first selection component with at least a second selection component;
provide a mechanism for moving a cursor from the first selection component to the at least second selection component connected to the first selection component, and
display, in the display unit, the one or more paths from the first selection component to at least the second selection component with an indication as to where the cursor would move upon activation of a given direction key of the input device.

9. The electronic device of claim 8, the control unit being further configured to display the path or paths from the said first selection component to selection components directly connected to the first selection component.

10. The electronic device of claim 8, the control unit being further configured to display the path or paths from the first selection component to all other selection components.

11. The electronic device of claim 10, the control unit being further configured to highlight the path or paths from the first selection component to the selection components directly connected to the first selection component.

12. The electronic device of claim 8, the control unit being further configured to activate the mechanism upon receiving an input indicating activation of a direction key of the input device.

13. The electronic device of claim 8, the control unit being further configured to display the said path or paths from the first selection component to the at least second selection component after receiving an activation input from the input device.

14. The electronic device of claim 8, the control unit being further configured to hide the display of the path or paths from the first selection component to the at least second selection component, when receiving no input from the input device during a determined time period.

15. An electronic device comprising:
display means for displaying information;
input means, comprising a plurality of direction keys, for inputting information;
means for providing in the display means an unstructured user interface menu with a plurality of selection components;
means for providing one or more paths connecting a first selection component with at least a second selection component;
means for providing a mechanism for moving a cursor from the first selection component to the at least second selection component connected to the first selection component, and
means for displaying the one or more paths from the first selection component to at least the second selection component with an indication as to where the cursor would move upon activation of a given direction key of the input means connected to the electronic device.

16. A computer program product encoding a computer program of instructions for executing a computer process for navigation guidance related to an unstructured user interface menu of an electronic device, the process comprising:
providing in a display unit of an electronic device an unstructured user interface menu with a plurality of selection components;
providing one or more paths connecting a first selection component with at least a second selection component;
providing a mechanism for moving a cursor from the first selection component to the second selection component connected to the first selection component, and
displaying the one or more paths from the first selection component to at least the second selection component with an indication as to where the cursor would move upon activation of a given direction key of an input device connected to the electronic device.

17. A computer program distribution medium readable by a computer and encoding a computer program of instructions for executing a computer process for navigation guidance related to an unstructured user interface menu of an electronic device, the process comprising:
providing in a display unit of an electronic device an unstructured user interface menu with a plurality of selection components;
providing one or more paths connecting a first selection component with at least a second selection component;
providing a mechanism for moving a cursor from the first selection component to the second selection component connected to the first selection component, and
displaying the one or more paths from the first selection component to at least the second selection component with an indication as to where the cursor would move upon activation of a given direction key of an input device connected to the electronic device.

18. The computer program distribution medium of claim 17, the distribution medium comprising at least one of the following mediums: a computer readable medium, a program storage medium, a record medium, a computer readable memory, a computer readable software distribution package, a computer readable signal, a computer readable telecommunications signal, and a computer readable compressed software package.
